(19) United States
(12) Patent Application Publication
(10) Pub. No.: US 2017/0368554 A1
(43) Pub. Date: Dec. 28, 2017

(54) INTEGRATED GRINDING AND STORAGE SYSTEM FOR OPTIMIZING AND ENHANCING PLANT PERFORMANCE OF PLANT-BASED MEDICAL THERAPIES AND RELATED CANNABIS USAGE

(71) Applicant: WILLIAM NICHOLS, NEW YORK, CN (US)

(72) Inventor: WILLIAM NICHOLS, NEW YORK, CN (US)

(21) Appl. No.: 15/487,586

(22) Filed: Apr. 14, 2017

Related U.S. Application Data
(60) Provisional application No. 62/326,862, filed on Apr. 25, 2016.

(51) Int. Cl. B02C 18/22; B02C 25/00; B02C 18/24; B02C 18/18; B02C 18/10; B65D 25/04; A47J 43/25

(52) U.S. Cl. CPC B02C 18/2216; B65D 25/04; B02C 25/00; A47J 43/255; B02C 18/18; B02C 18/10; B02C 18/24

(57) ABSTRACT

An integrated grinding and storage system for optimizing and enhancing plant performance for plant-based medical therapies and related uses of cannabis including an apparatus for grinding that includes a head operable to be removably attached to a receptacle or container. The head includes a magnet, an upper, inner grinding element, a lower grinding element, a shaft, and a neck sleeve. The upper, inner grinding element is in communication with the lower grinding element within the head. The grinding elements are operable to rotate relative to each other. The shaft extends between the upper and lower sections and magnetically couples with the grinding elements and orients them in relation to one another. The head may be manually or electrically activated.

### CROSS REFERENCES TO RELATED APPLICATIONS

This application claim priority from U.S. Provisional Patent Application No. 62/326,862 filed on Apr. 25, 2016, all of which is incorporated herein by reference as though it has been set forth in its entirety.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND OF THE INVENTION

### 1. Field of the Invention

Medicinal plants have been identified and used throughout human history. Plants have the ability to synthesize a wide variety of chemical compounds that are used to perform important biological functions, and to defend against attack from predators such as insects, fungi and herbivorous mammals. At least 12,000 such compounds have been isolated so far; a number estimated to be less than 10% of the total. Chemical compounds in plants mediate their effect on the human body through processes identical to those already well understood for the chemical compounds in conventional drugs; thus herbal or botanical medicines do not differ greatly from conventional drugs in terms of how they work. This enables botanical medicines to be as effective as conventional medicines, but also gives them the same potential to cause harmful side effects.

The use of plants as medicines predates written human history. Ethnobotany (the study of traditional human uses of plants) is recognized as an effective way to discover future medicines. In 2001, researchers identified 122 compounds used in modern medicine which were derived from “ethnomedical” plant sources; 80% of these have had an ethnomedical use identical or related to the current use of the active elements of the plant. Many of the pharmaceuticals currently available to physicians have a long history of use as herbal remedies, including aspirin, digitalis, quinine, and opium.

Cannabis, more commonly known as marijuana, is a genus of flowering plants that includes at least three species, Cannabis sativa, Cannabis indica, and Cannabis ruderalis, as determined by plant phenotypes and secondary metabolite profiles. In practice however, cannabis nomenclature is often used incorrectly or interchangeably. Cannabis literature can be found referring to all cannabis varieties as “sativas” or all cannabinoid producing plants as “indicas”. Indeed the promiscuous crosses of indoor cannabis breeding programs have made it difficult to distinguish varieties, with most cannabis being sold in the United States having features of both sativa and indica species.

The use of cannabis for social and medical purposes has been known for almost of all humanity's recorded history. Cannabis is most commonly administered via inhalation or consumption of marijuana-infused food and drink. However, since 1972 marijuana has been classified as a Schedule I drug under the U.S. Controlled Substances Act because the U.S. Federal Government considers it to have “no accepted medical use.” In stark contrast to this position, 23 of the 50 U.S. states and the District of Columbia have recognized the medical benefits of cannabis and have decriminalized its medical use.

President Obama has publicly commented on the recreational legalization of cannabis in Colorado and Washington stating that “it's important for it to go forward because it's important for society not to have a situation in which a large portion of people have at one time or another broken the law and only a select few get punished”. Indeed in the same interview, President Obama remarked about cannabis “I don't think it's more dangerous than alcohol. In fact, it is less dangerous than alcohol in terms of its impact on the individual consumer.” (Conor Friedersdorf January 2014, “Obama on Pot Legalization: ‘It's Important for it to go Forward’” The Atlantic). In line with the President's comments the U.S. Attorney General Eric Holder announced that the federal government would allow states to create a regime that would regulate and implement the legalization of cannabis, including loosening banking restrictions for cannabis dispensaries and growers (Jacob Sullum “Eric Holder Promises To Reassure Banks About Taking Marijuana Money ‘Very Soon’” Forbes January 2014).

In addition to these recent developments, the U.S. government has already set a precedent for patenting cannabis, and cannabis-related inventions. For example, U.S. Pat. No. 6,630,507 issued on Oct. 7, 2003 and assigned on the patent face to The United States of America, is directed to methods of treating diseases caused by oxidative stress by administering therapeutically effective amounts of a cannabidiol (CBD) cannabinoid from cannabis that has substantially no binding to the N-methyl-D-aspartate (NMDA) receptor, wherein the CBD acts as an antioxidant and neuroprotectant. A search of the U.S.P.T.O Patent Application Information Retrieval (PAIR) system also reveals the existence of thousands of cannabis related applications and issued patents including U.S. Pat. No. 8,034,843 (use of cannabinoids for treating nausea, vomiting, emesis, motion sickness), U.S. Pat. No. 7,698,594 (cannabinoid compositions for treatment of pain), and U.S. Pat. No. 8,632,825 (anti-tumoural effects of cannabinoid combinations) among many others.

Thus, despite the official position of the U.S. Federal Government, and as recognized by the states that have legalized it, cannabis has been shown to provide substantial benefits for medical uses. Cannabis is regularly used by a wide cross-section of society for recreational purposes as well as to treat a variety of maladies, conditions and symptoms including, but not limited to, the following: nausea, glaucoma, lack of appetite, mucous membrane inflammation, epilepsy, leprosy, fever, obesity, asthma, urinary tract infections, coughing, anorexia associated with weight loss in AIDS patients, pain, and multiple sclerosis.

However, cannabis intoxication (i.e., euphoria, relaxation) can occur and other side effects may also accompany its use, particularly with higher doses, specific cannabis varieties and/or over prolonged periods of usage. This is particularly true when there is little or no standardization of the resultant distributed product and no certification that the product is of a certain specified and repeatable efficacy. Undesirable side effects of using the available THC-predominant cannabis varieties can include, but are not limited to, the following: decreased short-term memory, dry mouth, impaired visual perception and motor skills, erectile dysfunction, lower fertility, red (i.e., blood shot) eyes, increased anxiety, occasional infarction, stroke, paranoia, acute psychosis, lowered mental aptitude, hallucinations, bizarre behavior, irrational panic attacks, irrational thoughts and various other cognitive and social problems.

Some of the negative or undesirable side effects from using available cannabis varieties for medical and recreational purposes are related to the plant's content of the chemical, DELTA 9-tetrahydrocannabinol (THC). A major hurdle to the more wide-spread acceptance of cannabis and its legalization is that the land races and commercially available cannabis genotypes (of drug varieties) contain relatively high concentrations of THC. Indeed the average THC content of traditional recreational cannabis has risen over the years from an average of 0.74 in 1975, to 3.35% in the 1990's, and average of 6.4% in 2003 (Annual Reports Nov. 9, 1999 to Nov. 8, 2003 of Mahmoud A. ElSohly, PhD, Director of the National Institute on Drug Abuse (NIDA) Marijuana Project at the National Center for Natural Products Research, School of Pharmacy, University of Mississippi). Recreational growers now report THC potency values as high as 30%.

There is a real need for cannabis and other medical plant varieties for potential medical use that may be ground and employed in a standardized and replicatable manner to permit them to be used in a controlled and uniform dosage and particulate size, in to provide consistent medical benefits to be realized from their respective use. The inventions described herein meet that long-felt need.

### 2. Prior Art and Description of the Related Art

Conventional grinding devices are composed of a stator and a rotor, at least one of which is provided with teeth to form a jaw.

In such a device, the rotor is driven rotationally by way of a drum forming the body of the device, fixed on the neck of the reservoir but able to rotate freely. In contrast, the stator is immobilized with respect to rotation relative thereto. Mills for grinding plant material of this type are provided with means for adjusting the ground product, acting on the jaw spacing formed by the rotor and the stator by varying the axial position of the rotor relative to the stator. These latter components represent frustoconical bodies of revolution, albeit having different conicities, in such a way that the displacement of one relative to the other causes the spacing and consequently the adjustment to vary.

For example, known systems make this adjustment of the rotor relative to the stator by way of a screw system. However, in this case it is often not possible to provide marks for positioning the stator relative to the rotor, and so it is often not possible to identify the grinding fineness, which is selected according to the plant material that are being ground and can vary from one consumer to another and one type of plant to the other.

To remedy this shortcoming, different systems have already been proposed in order to achieve an adjustment of the ground product in graduations, such as described in International Patent Application No. WO 2004/037057, by making the rotor integral with an annulus furnished with pins intended to be positioned in openings of the body, the openings being furnished with notches corresponding to different sizes of the ground product.

According to this patent application, the openings are inclined in such a way that the rotational movement of the annulus induces an axial translational movement of the rotor, modifying the distance between it and the stator that is complementary to it. However, such a device typically does not permit continuous adjustment of the ground product because the rotor is integral with the adjusting element, which must be locked in the body to form the rotor of the mill.

Thus, there continues to be a need for a grinding system that permits continuous adjustment of the ground product in accordance with the wishes of the user and the nature of the plant material being ground.

In the event that an electrical grinder is employed, a system for dosing may be based on a ground volume criterion. There are devices provided for the grinder to be associated to a dosing chamber, wherein the ultimate particulate material produced by the grinder through the grinding process held in a dosing chamber. The dosing chamber may be partly delimited by a flexible sheet, which becomes deformed, that is, moves by the effect of the build up of particulate cannabis material in the same dosing chamber. This movement or deformation causes the actuation of a micro-switch that interrupts the grinding, thus.

In order to obtain an adjustment of the dose, the micro-switch may be adjusted into position by a manual adjustment system, so it is actuated by the deformable sheet defining a wall of the dosing chamber at variable values of the volume of coffee powder built up in the dosing chamber. An example of a dosing chamber of this type is described in U.S. Pat. No. 4,659,023. However, this device is not capable of modifying the amount of particulate material at each cycle within so wide ranges as to allow the uniform generation of a single, uniform dose of cannabis.

Another example of a dosing chamber and related grinder is described in GB-1495893 which describes a dosing device, wherein systems are adopted which allow alternately dispensing a single dose or a double dose. To this end, the grinding unit is associated to at least two dosing chambers, each of which can be set to open when a preset amount of particulate material within a relatively limited range is reached. While this known device allows greater flexibility in terms of setting of the amount of a dose of cannabis at each cycle, it exhibits several drawbacks. In particular, since a dual dosing chamber is required, the device is cumbersome and very expensive.

It is also a further aspect of the invention to provide an integrated system which overcomes other issues that plague medicinal plant users who need to smoke the plant material. Misplaced paraphernalia can be a common annoyance for smokers. A missing accessory such as a lighter can prevent the smoker from smoking altogether. As such, it is common to store paraphernalia in a separate bag or pouch for convenient access and to prevent losing the paraphernalia.

However, ultimately, a bag or pouch may cause the same problems that the bag or pouch was originally intended to resolve as it is possible to misplace the bag or pouch as well. This can be particularly problematic, particularly if, for example, one requires medical marijuana in order to alleviate epileptic seizures that may occur at unpredictable times. The present invention seeks to address the aforementioned issues as well as provide the user with a convenient and practical solution.

To solve this problem, Velcro or other re-stickable elements may be added to the bag/pouch-that holds both a regular sized bic lighter and the common size for cigarette papers used to make marijuana cigarettes. The pouch/bag or “Companion Pouch” as it is called by the inventor, is a clear plastic bag that is zip-lock sealable and attaches to both inside the Jar and on the outside of the Jar.

### SUMMARY OF THE INVENTION

The present invention relates generally to an integrated grinding and storage system for optimizing and enhancing plant performance for plant-based medical therapies and related uses of cannabis including an apparatus for grinding that includes an operable grinding head which is to be removably attached to a receptacle or container. The head includes a magnet, an upper, inner grinding element, a lower grinding element, a shaft, and a neck sleeve. The upper, inner grinding element is in communication with the lower grinding element within the head. The grinding elements are operable to rotate relative to each other. The shaft extends between the upper and lower sections and magnetically couples with the grinding elements and orients them in relation to one another. The head may be manually or electrically activated.

Grinders are important tools to break down various substances from solid or dense masses into finer substances. Currently, grinders are structured such that there is not an easy or convenient way to get the ground substance out of the grinder or to permit uniformity in the grinding process. Currently, options include pinching the contents out or dumping them from a vessel that is not configured for pouring. Therefore what is needed and what is provided by the instant invention is a grinder that allows for easy and efficient removal of the ground material, especially cannabis, from the grinder while permitting a uniformity in the grinding and retention of any excess ground material in a convenient, uniform dosing.

The invention combines a manual grinder or an electrical grinder, that adheres to the lid of the jar through a magnet on the grinder, with a Companion Pouch that holds a regular sized Bic lighter and cigarette papers all in a glass jar that has a medal lid. The Companion pouch can be attached to either the inside or outside of the jar. The invention also uses a lithium rechargeable battery for it's electrical grinder, thus saving space and weight of the total invention, while also saving the environment from the use/disposal of batteries. The jars also float, are resistant to breaking and are waterproof.

The electrical grinder attaches itself with a magnet to the under side of the metal lid of the jar. Unlike the manual grinder the electrical grinder does not have a separate small chamber to store grounded material. However, all marijuana material grounded or not, can be held in the dosing part of jar. The electrical grinder uses a rechargeable battery and can grind all hemp material within 5 seconds.

Excess grounded plant particulate, produced by the hand grinder, can be stored in the storage chamber of the grinder itself. The grinder has 3 stages, a top section with a flat back (that has a flat magnet that covers the whole back section) and shark teeth spikes on the other side, and a bottom section that has one side with shark teeth spikes and on the other side it has a ½″ long storage area which has a cap.

When a customer buys the Grassjar, they will be getting 4 things, either a manual or electrical grinder, a 8 oz glass jar—with manual grinder/14 oz glass jar-with electric grinder, a regular sized bic lighter and a common sized cigarette papers.

The present invention further relates generally to a container or receptacle for holding smoking paraphernalia. More specifically, the present invention is a resealable, hard walled container that may have a flexible inner separation wall for holding smoking paraphernalia such as a lighter, paper, and medical marijuana in its generally unground form.

The present invention may be made of glass, plastic or other hard material that holds smoking paraphernalia. The present invention may have one or more flexible inner separation walls to permit the segregation of materials from one another. Thus, the paper may be kept separate from the unground material, in one compartment, while excess ground material may be advantageously stored in another compartment.

The present invention allows various types of smoking paraphernalia to be stored along with the smoking material, allowing the user to easily and conveniently access the paraphernalia as needed. The present invention is able to reduce the likelihood of misplacing smoking paraphernalia as well. In addition to storing smoking paraphernalia in a single accessible location, the present invention provides aesthetic appeal and may be customized to the user's preferences.

This is the first invention that has combined all the elements needed to store, grind, roll, and light marijuana (cigarette). The invention may employ canning jars that help preserve and cure the cannabis whether it is ground or in flower form.

The invention also may have a Companion Pouch that holds a regular sized Bic lighter and cigarette papers. The pouch is made out of a clear plastic zip-lock bag. Because the Companion Pouch may advantageously employ Velcro or other re-stickable elements, it will permit the pouch to stay in place inside the jar as well as outside the jar. In addition to using velcro like material to hold the Companion Pouch inside the jar as well as outside, a magnet may be used in the sleeve of the Companion Pouch.

The subject matter of this application may involve, in some cases, interrelated products, alternative solutions to a particular problem, and/or a plurality of different uses of a single system or article.

### BRIEF DESCRIPTION OF THE DRAWINGS

FIG. 1 provides a perspective view of an embodiment of the grinder.

FIG. 2 provides a bottom view of an embodiment of the grinder.

FIG. 3 provides a side view of an embodiment of the grinder.

FIG. 4 provides an exploded view of an embodiment of the grinder.

FIG. 5 provides a perspective view of an embodiment of the grinder in conjunction with a form of container having a flexible partition disposed therein.

FIG. 6 provides a perspective view of an embodiment of an electrically powered grinder.

FIG. 7 provides a perspective view of an embodiment of an electrically powered grinder in conjunction with a form of container having a flexible partition disposed therein.

FIG. 8 is an exploded view of an embodiment of an electronically powered grinder in conjunction with a grinder wire configuration and form of container.

### DETAILED DESCRIPTION OF THE INVENTION

In one aspect, a grinder is provided. The grinder comprises a top portion, upper chamber, lower chamber, and bottom portion, all removably attachable together. The top portion is formed as a disc having a substantially circular cross section. Further, the top portion may have a quantity of teeth protruding from its inner bottom surface.

The upper chamber may be rotatably connected to the top portion, and may form a cavity in which a medicinal plant for grinding may be placed. A second quantity of teeth protrude from a lower inner surface of the bottom portion of the cavity, extending towards the quantity of teeth of the top portion when the two are rotatably attached. An aperture or plurality of apertures may be formed intermediate the two sets of teeth so that they do not impinge or interfere with one another during the grinding process, yet provide sufficient rotational friction relative to one another to permit the plant material to be ground effectively and consistently. Moreover, a lipo battery used in the electric grinder may be inside the shaft and can advantageously have an outlet embedded in bottom of shaft-next to the On/Off button at base/bottom of shaft handle for recharging connections.

A lower chamber may be removably connected to the upper chamber, the aperture of the upper chamber communicating with a cavity of the lower chamber. The two chambers are advantageously centered with regard to one another and are magnetically interfixed to permit the sets of teeth to remain functionally disposed with relation to each other. Finally, a magnetic element may be affixed to the bottom portion of the lower section of the grinder to permit it to be removably attached to an upper side of the container top.

In another aspect, a method of grinding plant material, and particularly cannabis, is provided. The method may begin with placing a quantity of unground cannabis in a cavity of an upper chamber of a grinder. A top portion and the upper chamber may be rotated against each other, grinding the cannabis and allowing the ground cannabis to pass between the teeth of the upper and lower chambers once it has become of the desired optimal dimension.

According to the present disclosure, a canister includes a container and a grinder coupled to the container. The grinder is provided to grind and dispense optimal dimension cannabis which is stored within the container, either in a ground condition or in an unground condition, each within its compartment and separated by flexible wall separations.

In illustrative embodiments, the grinder may adjustable and may have associated therewith a motor means to power the two sections of the chamber in a rotational manner relative to one another.

Additional features of the disclosure will become apparent to those skilled in the art upon consideration of the following detailed description of illustrative embodiments exemplifying the best mode of carrying out the disclosure as presently perceived.

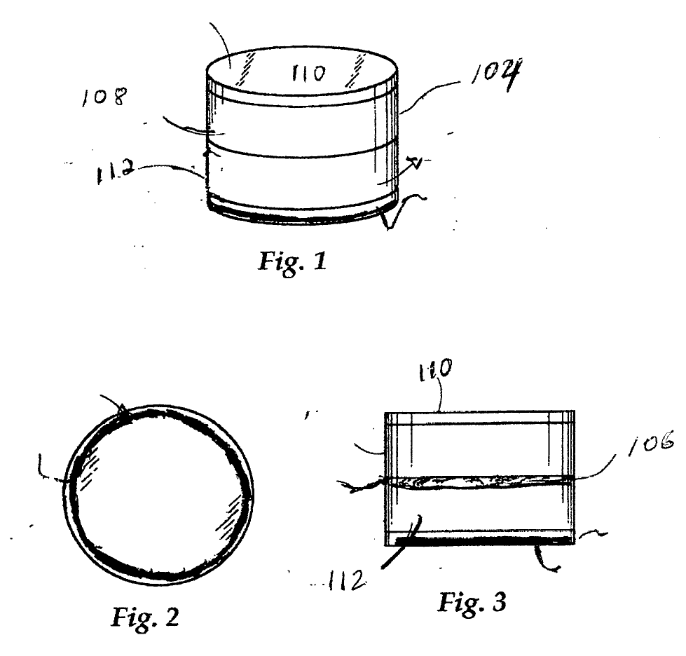

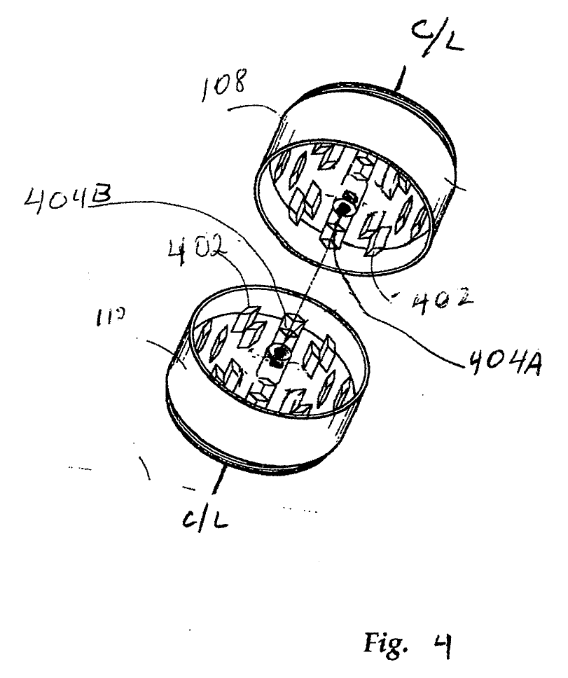

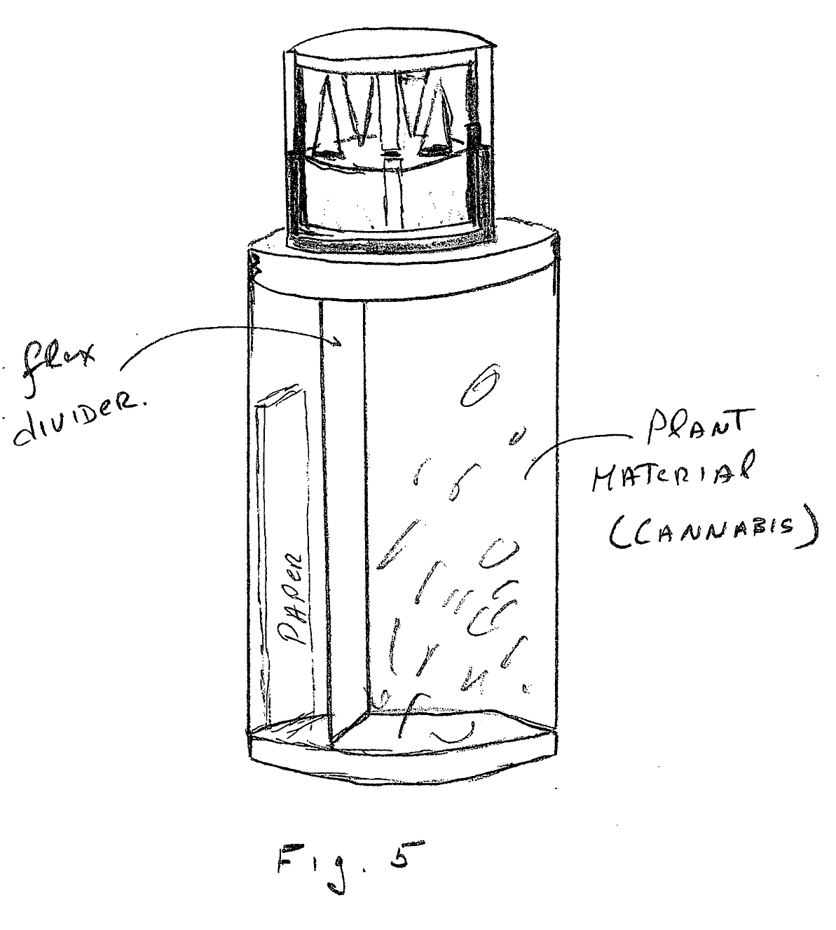

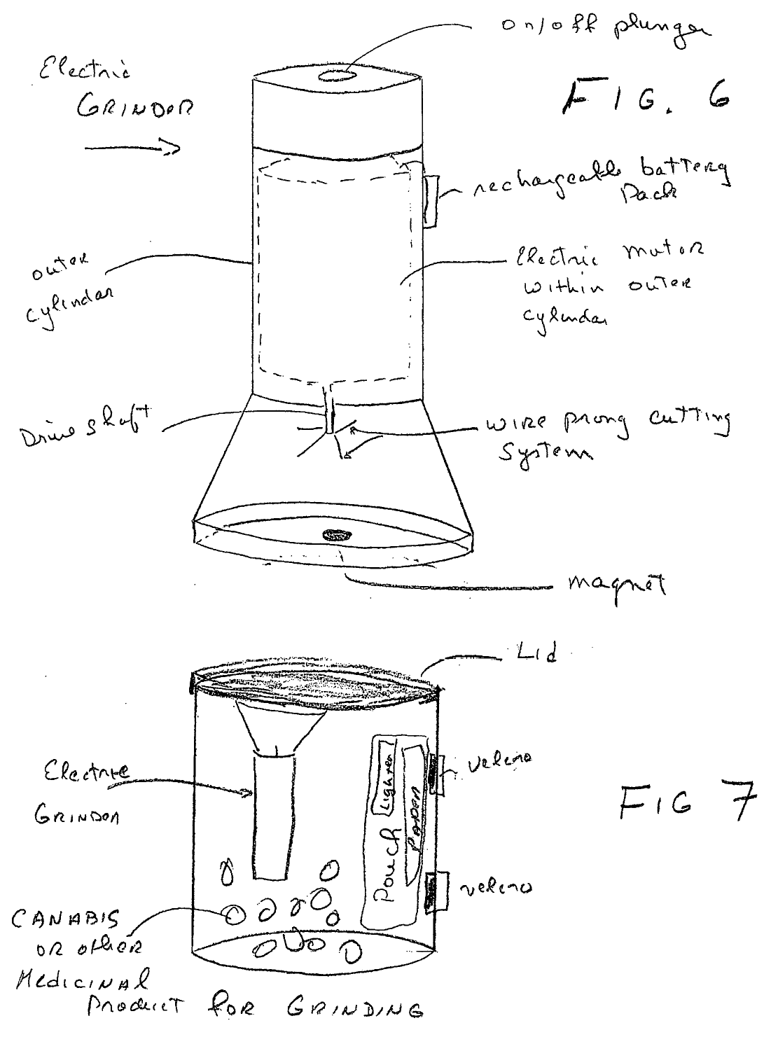

Referring now to the drawings, and more specifically FIGS. 1-6, wherein the showings are for the purpose of illustrating the preferred embodiment of the invention only and not for the purpose of limiting the same, a grinding apparatus 500 is generally shown in combination with a container or jar 502 having a substantially cylindrical shape and configuration. The container or jar 502 includes an outer wall 504 having mouth 506 which may be of a smaller or equal diameter to that of the outer wall. The mouth 506 may have a sealing top 508 which is pivotally attached to the container or jar 502 or a plurality of threads (not shown) that bound the opening at the top 510 for providing access inside the container or jar while simultaneously providing a means for securing the sealing top 508 to the a lower section 512 of the container or jar 102.

As will be explained in greater detail herein, the container or jar 502 is stored in an upright manner, with the flexible dividers 520 being disposed vertically within the container or jar and a grinder 100 is magnetically and removably secured on the upper threaded mouth 506 or pivotally mounted sealing top 510.

The overall integrated system comprises the grinding apparatus 100 of a substantially cylindrical shaped outer wall surface 104 and having a lower portion 112 rotatably attached to an upper portion 108 wherein the two portions form an inner grinding chamber. Each of the lower portion 112 and the opposing upper portion 108 have a mating sleeve which permits them to be housed within one another and the upper and lower portions each have a plurality of longitudinal tooth members 402 substantially perpendicular to the circular section of each portion and parallel to the cylindrical sides thereof.

The lower portion 112 also includes a center point throughbore 404A having a magnet affixed thereto and laterally extending to a second center point throughbore 404B having a second magnet affixed thereto such that the two magnets and throughbores serve to align the upper 108 and lower 112 portions relative to one another and maintain the points of the teeth 402 from impinging on circular surfaces which they face. By extending the length of the throughbore, the lower section of the grinder may also serve as a storage receptacle for the ground cannabis such that it is optimally ground and is not further ground. This also causes the grinding to take place as between the upper and lower teeth, which permits an abrading action, rather than between the tooth point and a lower surface, which would result in a compressive situation which is counter productive to the entire concept of grinding the cannabis.

A first plurality of longitudinal protrusions or teeth 402 are circularly disposed on the inner circular wall of the upper portion 108 closer to the upper peripheral edge thereof. A number of opposing longitudinal protrusions or teeth 402 are circularly disposed on the inner circular wall of the lower portion 112 further from the upper peripheral edge thereof than the upper teeth. Each upper tooth 402 is dimensioned and configured to bypass the corresponding tooth 402 of the lower portion 112 of the grinding apparatus but to permit any plant material that is located between the vertical surfaces of them to be abraded.

A plurality of teeth 402 are located on the circular walls of the upper and lower portions of the grinder in circular configurations and in complementary dispositions such that each is in a non-contact position to prevent actual touching, but are in complementary circles to permit abrasion of the cannabis. The above configuration creates an alternating series of peaks and valleys extending from the peripheral edge of the each of the upper and lower portions of the grinder to center of each. The peripheral rings formed by each set of teeth allowing the upper portion and the lower portion to rotate relative with one another about a common vertical axis. The axis has disposed thereon a centering and retention magnet system.

The grinding apparatus is assembled together in the following manner. The lower portion of the grinding apparatus is inserted within the sleeve from the top so that each tooth is juxtaposed to but not obstructed by the corresponding tooth on the lower sleeve and wherein the rotation of the upper sleeve relative to the lower sleeve results in the rotation of the upper portion relative to the lower portion of the grinding apparatus for grinding the cannabis or other plant derived product.

Referring to FIGS. 6 and 7 there is shown a perspective view of an embodiment of an electrically powered grinder 600 in conjunction with a form of container 700 having a flexible partition 520 disposed therein. The grinder 600 has a unique wire prong cutting system 610 to permit the maceration of hemp or other similar medicinal items 630 without shredding or clumping the dried and cured items. The grinder 600 employs an on/off plunger switch 602 that turns the rechargeable battery pack 604 on and off to provide power to an electric motor 606 within the cylinder 608. This unique and inventive set of rotor prongs 620 are advantageously designed so that they grind the hemp or other herbs, to a fine powder, but do not grind the stems or sticks from the bud, leaving the customers with just ground hemp or herbs without having any foreign or unwanted stems. The wire grinder 610 is unique, among other reasons, for the following unexpected results:

1) It does not chop off fingers if someone under the influence of herbs decides to run the device without the grinder jar.
2) The wire rotating through open medium (green grass, herbs . . . ) does not snap or cut stems.
3) The “fluff factor” is very dependent on a wire rotating thru the green herb versus a cutting blade.

Thus, each of the wires 620 is a tiny bicycle spoke that rotates very quickly from the hub, without the rim. This unexpectedly cause tissue segmentation and separation, which may also be employed in the biological assay science areas where they commonly have to cryogenically cool bio-matter and tissues to sample because cutting causes cluster formation and clumping. Thus, it could serve as a pre-centrifuge device.

The wires 620 rotating break the biological tissue down (herbs or hemp/cannabus in this case) based on tearing or ripping of the surface at the weakest point, yet the stronger and flexible material, like the stem just gets pushed along. Thus, the contaminates just get pushed along because they have larger shear forces that do not get “chopped.” Technically, this is a purification device based on the wire cutting system.

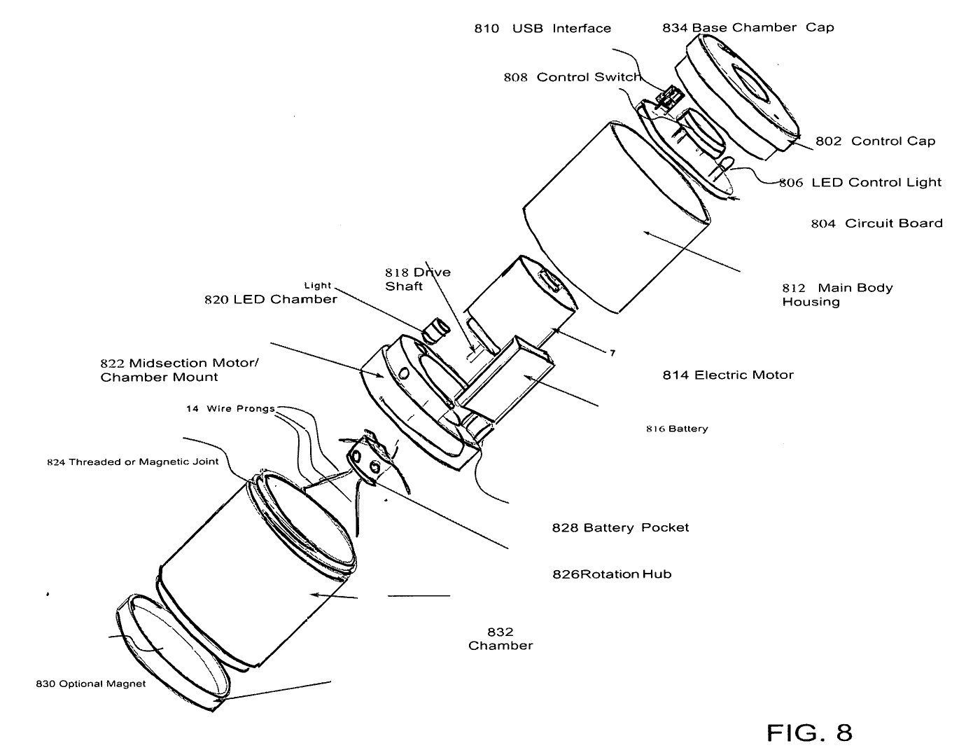

Referring to FIG. 8 as a representation of a preferred embodiment of the invention, there is shown an integrated grinder 800 comprising an upper control cap 802 on which there is advantageously disposed a plunger switch 602, or other form of control switch. The control switch 602 may be employed to select, from a variety of cutting speeds, directions of rotation and alternating rotation directions that may be advantageously and selectively programmed into a programmable control circuit board 804.

There can be housed within the control cap 802 the control switch 602 which is electrically connected to the programmable control circuit board 804 that is employed to control an electric motor 814 located within a main body housing 812. There can also be housed within the control cap 802 a LED control light 806 that can be selectively employed to display whether the electric motor 814 is being powered and, if desired, the particular program that is currently being employed to power the electric motor 814. Thus, by way of example, the control light 806 may be red if the electric motor 814 is being powered to run in a single direction, yellow if it is in alternating rotation mode, blue if it is in low speed mode and green if it is off.

There can further be housed within the control cap 802 a charging port or USB interface 810 to permit a rechargeable battery pack 816 to be supplied with power in order to recharge it as needed. The rechargeable battery pack 816 may be disposed within battery pocket 828 advantageously formed as a part of a midsection motor chamber 822.

The midsection motor chamber 822 may be molded to permit the mounting of the electric motor 814 in a complementary depression or aperture so that a drive shaft 818 extends through the midsection motor chamber 822 and may be affixed to a rotation hub 826 upon which are disposed a series of wire prongs 814. As may be best appreciated in FIG. 8, the wire prongs 814 may be disposed both on the superior surface and the lower surface of the rotation hub 826 and, in one preferred embodiment, are disposed such that the superior surface wire prongs 814 are approximately 120 rotational degrees from one another and the lower surface wire prongs 814 are also approximately 120 rotational degrees from one another. The upper and lower set of wire prongs 814 are disposed such that they intermediate one another when viewed from the upper surface and do not overlap. While three upper and three lower wire prongs 814 are shown, those skilled in the art can appreciate that alternate numbers of such prongs may be employed.

It is also best appreciated in FIG. 8 that the wire prongs 814 may be disposed both on the superior surface and the lower surface of the rotation hub 826 and, in one preferred embodiment, are disposed such that the superior surface wire prongs 814 are longer than the lower surface wire prongs 814. This configuration, along with the above tripartite prong 814 structure has been advantageously found to provide unexpected benefits and results that will be described hereinafter.

Continuing with the description of the preferred embodiment exemplified in FIG. 8, a lower chamber 832 having a threaded or magnetic joint 824 is rotationally or magnetically secured to the main body housing 812 such that the rotational hub 826 and the wire prongs 814 carried thereon are within the chamber 832 and extend into the chamber 832 approximately one third to one half of the height of the chamber. An optional magnet 830 may be affixed to the lower portion of the chamber 832 to permit the entire assembly to be stored by magnetically securing it to an iron or other surface.

Breaking up cannabis and other material that may be used for medicinal purposes is just a part of the process. Over the years the technology from two, to three, and now four chamber grinders have taken the market by storm, filling the shelves of shops and online marketplaces. They are great for stationary spots such as the home, but do not provide for the separation and variation in the grind that is achieved with the elements of the instant invention.

How you grind your raw organic material including cannabis is a personal preference, but there are certain processes that require it. Breaking buds up allows the material to burn cleanly and fill the receptacle used for administration more fully, therefore giving you more surface area to roast the product, while also removing stems. However, the stem removal is still not done effectively by the breaking process.

If one chooses to go with a traditional, prior art grinder, they tend to be equipped with a chamber specifically designed to catch kief, which is the very potent result of separating trichomes from the plant. This can be more effectively extracted by the use of the instant invention, which lets it collect in the chamber.

Using one's fingers, which is often a way that is currently used to break up organic flower material, can lead to the loss of THC crystals and other active ingredients and chemical by having them remain on one's fingers. Not only do you lose some THC resin heads on your hands, but you'll also tarnish some of the resins left on the bud that you've been touching with the oil on your skin.

Cannabis patients and consumers who smoke or vape the flowers of the plant—about 95 percent of users—must grind their buds to create a fine texture suitable for airflow and trichome exposure. This is especially true of vaporizing, where a finer grind will result in more cannabinoids and terpenes being exposed to the flow of hot air that causes their vaporization.

Grinders play a very important role in the daily lives of tens of millions of cannabis consumers as well as consumers of other organic materials that are consumed for medicinal, digestive, recreational or other uses. Often an afterthought, many patients use cheap plastic models or scissors to cut their buds. While there's no right or wrong, and consumers should choose a method of grinding their herb that satisfies their particular preferences and lifestyle, most patients use a conventional grinder. While the best grinders are made from top-tier metals like stainless steel, anodized aluminum, and even titanium and are sometimes medical grade in quality and many employ magnets as part of a simple and reliable lid closure system, none of them provide the unforeseen benefits of separation and variable grind, along with a consistence each grind and repeatable grind size.

Not everyone uses an herb grinder to break up their organic material for smoking, eating or other forms of ingesting or vaporization. Some simply separate it by hand. Still others just shove a small bud, or “nug,” into a bowl, often a wooden or glass spoon, and smoke it. This is typically not encouraged, simply because the herb burns much more smoothly if ground, allowing hot air (in the case of vaping) and flame (when smoking) to more freely and evenly pass through it. The instant invention also helps prevent the scorching of stems and leaf matter that damage taste and offer almost no plant resin by permitting the bud to be macerated while leaving the stems and leave matter substantially intact for deposit in the chamber of the invention.

Mixing cannabis and tobacco is sedating and can be accomplished with the instant invention effectively. Organic materials that are consumed can be ground uniformly by the instant invention. Every person has a different experience with cannabis and tobacco. Nicotine and THC both induce euphoria. A 2009 study found that combining tobacco and cannabis created more available THC. This means that one feels the effects of cannabis very quickly, and more of it will be available for your body to use. This is also true in situations were organic materials need to be pulverized uniformly for effective consumption. The instant invention can accomplish this purpose.

The study examined the THC content in smoke captured from a pure cannabis joint and a spliff containing only 25% cannabis. The results are surprising. THC in the smoke from the pure cannabis joint measured around 32.70 milligrams per gram. THC increased to 58.90 milligrams per gram. This lead the study authors to conclude that tobacco seemed to increase the vaporization efficiency of THC by as much as 45%. The extra surge of THC coupled with nicotine causes a special kind of head rush. Tobacco causes a tingly, light-headed feeling. It also stimulates adrenaline production. Your heart pumps faster, your blood pressure rises. You're stimulated and ready to go. This bump in adrenaline might make you feel a little shaky.

As was set forth above, the invention employs a completely unique method and achieves an unanticipated result in the method of breaking down/grinding organic material to a powder form, from herbs to tea, to all tobacco types, wet or dry. This method utilizes the wire prongs 814 which are of a certain length relative to one another and relative to the size of the chamber, in conjunction with centrifugal force which spins the material within in a defined sized chamber.

The resultant force confluence of centrifugal force in combination with the dynamic cutting forces generated by the wire prongs 814 cause a decomposition or breakdown of virtually any organic (flower) matter from its stems and/or seeds. The unexpected result is that the useful part of the organic material (the flower) is broken down into useable form efficiently, without breaking down the stems or seeds that generally form a part of the overall product introduced into the assembly, whether in hard form-like rock candy or soft material, while leaving the highest quality undisturbed organic sample in properly pulverized or macerated form. It will be appreciated that the wire prongs 814 are adjustable, both as to size and angle, as is the speed of the rotation hub 828. Similarly, the rotation hub 828 can go in one direction or alternate either by programing or by a pre-jam sensing which permits it to sense that it is going to jam and thus causes it to reverse rotational direction.

The above system also provides a variety of consistently grounded gradations, from rough to fine, all within a few seconds of introducing the material into the device. Because of these consistent grinding results, the invention leads itself to variable grinding/maceration of items ranging from cooking or edible organic items to leaf tobacco for cigarette rolling. By way of example only and not as a limitation, the grinder may be used in these areas:
1. tea-match a tea especially-as it needs to be (consistently) and finely ground into powder,
2. coffee beans,
3. cigarette tobacco,
4. herbs,
5. cannabis flowers.

There is also shown a form of the Companion Pouch 520 that may be used to hold a regular sized lighter 740 and cigarette papers 750. The pouch is made out of a clear plastic zip-lock bag. Because the Companion Pouch 520 may advantageously employ Velcro (not shown) or other re-stickable elements, it will permit the pouch to stay in place inside the jar as well as outside the jar. Although the battery pack for the electric motor is shown as being disposed outside of the outer cylinder, it may also be advantageously placed within the chamber or at some other location proximate to the electric motor.

Certain terminology is used in the following description for convenience only and is not limiting. The words “above,” “below,” “lower,” and “upper” designate directions in the drawings to which reference is made. The terminology includes the words noted above as well as derivatives thereof and words of similar import.

Although the foregoing has been described in some detail for purposes of clarity, it will be apparent that certain changes and modifications may be made without departing from the principles thereof. It should be noted that there are many alternative ways of implementing both the systems and methods described herein. Accordingly, the present embodiments are to be considered as illustrative and not restrictive, and the invention is not to be limited to the details given herein, but may be modified within the scope and equivalents of the appended claims. Further, the present invention is not limited to the embodiments described above, and variations, substitutions, combinations of elements and derivative means and systems may be undertaken and implemented by those skilled in the art and are all within the scope of the claims set forth hereinafter.

What is claimed is:

1. An organic material grinder, comprising: a container configured to hold an organic product to be ground; an electric motor assembly; a drive shaft having a drive end associated with the electric motor assembly and a hub end capable of being positioned within the container such that the drive shaft is parallel to the center line longitudinal axis of the container and configured to rotate; a rotation hub positioned on the hub end, said rotation hub having an upper face and a lower face; at least one upper wire prong extending from the upper face in a radial direction from the longitudinal axis; at least one lower wire prong extending from the lower face in a radian direction from the longitudinal axis wherein said upper wire prong and said lower wire prong are rotationally displaced from one another; and a programmable circuit board capable of permitting the electric motor assembly to vary the speed and direction of rotation of the rotation hub and associated wire prongs to permit the organic material to be ground.

2. The organic material grinder of claim 1, wherein the upper wire prongs consist of three radially extending prongs separated from one another by approximately 120 degrees.

3. The organic material grinder of claim 1, wherein the lower wire prongs consist of three radially extending prongs separated from one another by approximately 120 degrees.

4. The organic material grinder of claim 1, wherein the upper wire prongs consist of three radially extending prongs separated from one another by approximately 120 degrees and the lower wire prongs consist of three radially extending prongs separated from one another by approximately 120 degrees wherein the upper and lower wire prongs are rotationally displaced from one another and configured to grind the organic material.

5. The organic material grinder of claim 4, wherein the rotation hub extends within the container approximately one third of the distance between the upper end and the bottom of the container.

6. The organic material grinder of claim 4, further comprising: a control switch to permit the speed and direction of rotation of the drive shaft and attached rotation hub to be selected and adjusted through the programmable circuit board.

7. The adjustable organic material grinder of claim 6, further comprising: a midsection container cap positioned on the upper end of the container.

8. The adjustable organic material grinder of claim 7, wherein the midsection container cap includes a mounting section to hold the electric motor and a rechargeable battery for powering the electric motor, wherein the drive shaft extends through the container cap and the drive shaft rotates with respect to the container such that an organic product between the wire prongs and the interior wall of the container is ground.

9. The adjustable organic material grinder of claim 8, further comprising: a housing into which the electric motor and battery are situated, said housing being of substantially the same diameter as the midsection container cap and being removably affixed thereto at one end and further comprising a control cap removably affixed to the opposing end of the housing.

10. The adjustable organic material grinder of claim 9, further comprising: a charging interface electrically connected to the rechargeable battery.

11. The adjustable organic material grinder of claim 6, wherein the programmable circuit board control is programed to permit the speed and direction of rotation of the drive shaft and attached rotation hub to be selected and adjusted manually.

12. The adjustable organic material grinder of claim 6, wherein the programmable circuit board control is programed to permit the speed and direction of rotation of the drive shaft and attached rotation hub to be selected and adjusted as a function of the sensing by the rotation hub of a jamming force created by the organic material being ground.

13. The organic material grinder of claim 1 wherein the organic material consists of a useable flower component and an unuseable stem and leaf component.

14. The organic material grinder of claim 13 wherein the organic material useable flower component is ground and pulverized by the wire prongs and unuseable stem and leaf component is not ground and is separated from the ground useable flower component.

15. The organic material grinder of claim 13 wherein the useable flower component grind may be varied.
